(19) United States
(12) Patent Application Publication
(10) Pub. No.: US 2017/0252795 A1
(43) Pub. Date: Sep. 7, 2017

(54) Gear And An Electric Actuator Provided Therewith

(71) Applicant: NTN Corporation, Osaka-shi (JP)

(72) Inventors: Yoshinori IKEDA, Iwata-shi (JP); Isao MIKURIYA, Iwata-shi (JP); Hayato KAWAGUCHI, Iwata-shi (JP)

(73) Assignee: NTN Corporation, Osaka-shi (JP)

(21) Appl. No.: 15/600,926

(22) Filed: May 22, 2017

Related U.S. Application Data
(63) Continuation of application No. PCT/JP2015/082673, filed on Nov. 20, 2015.

(30) Foreign Application Priority Data
Nov. 21, 2014 (JP) 2014-236133

(51) Int. Cl. B21D 53/28; F16H 1/00; B23P 15/14

(52) U.S. Cl. CPC B21D 53/28; B23P 15/14; F16H 1/00

(57) ABSTRACT

A gear that can be utilized in an electric actuator has teeth formed on its outer circumference and a central hole formed at its center. An intermediate region is positioned between a peripheral portion near the teeth and a boss near the central hole. The intermediate region has a thickness thinner than the peripheral portion and the boss. A plurality of weight-lightening apertures is circumferentially and equidistantly formed in the intermediate region. A vibration absorbing member of synthetic rubber is formed on both side surfaces of the intermediate region. The vibration absorbing member is integrally connected on each side through the weight-lightening apertures. The vibration absorbing member is attached to the radially outer side rather than an outer diameter of a bearing arranged adjacent to the vibration absorbing member.

### CROSS-REFERENCE TO RELATED APPLICATIONS

This application is a continuation of International Application No. PCT/JP2015/082673, filed Nov. 20, 2015, which claims priority to Japanese Application No. 2014-236133, filed Nov. 21, 2014. The disclosures of the above applications are incorporating herein by reference.

### FIELD

The present disclosure relates to an improved gear for suppression of generated abnormal noise and to an electric actuator including the gear. The gear is provided on a ball screw mechanism generally used in motors in general industries and drive sections of automobiles, etc. More particularly, the present disclosure relates to an electric actuator used in automobile transmissions or parking brakes that convert a rotary motion, from an electric motor, to a linear motion of a drive shaft, via the ball screw mechanism.

### BACKGROUND

Gear mechanisms, such as a trapezoidal thread worm gear mechanism or a rack and pinion gear mechanism, have generally been used in various kinds of drive sections as mechanisms to convert rotary motion of an electric motor to axial linear motion of the electric linear actuators. These motion converting mechanisms involve sliding contact portions. Thus, power loss is increased and simultaneously size of electric motor and power consumption are also increased. Thus, the ball screw mechanisms have been widely used as more efficient actuators with low frictional loss.

An electric actuator using a ball screw mechanism is shown in FIG. 5. The electric actuator 51 includes a housing 52 with a first housing portion 52a and a second housing portion 52b. An electric motor 53 is mounted on the housing 52. A speed reduction mechanism 57 transmits the rotational power of the electric motor 53 to a ball screw mechanism 58, via a motor shaft 53a. The ball screw mechanism 58 converts the rotational motion of the electric motor 53 into axial linear motion of a drive shaft 59, via the speed reduction mechanism 57. The ball screw mechanism 58 includes a nut 61 formed with a helical screw groove 61a on its inner circumference. The nut 61 is rotationally and axially immovably supported via a pair of supporting bearings 66 mounted on the housing 52. A screw shaft 60 is coaxially integrated with the drive shaft 59. The screw shaft 60 has a helical screw groove 60a on its outer circumference corresponding to the helical screw groove 61a of the nut 61. The screw shaft 60 is inserted into the nut 61. The screw shaft is axially movable and non-rotationally supported via a plurality of balls.

The electric motor 53 is mounted on the first housing portion 52a. A bore 63a and a blind bore 63b are formed, respectively, in the first and second housing portions 52a, 52b to contain the screw shaft 60. The speed reduction mechanism 57 includes an input gear 54, secured on the motor shaft 53a, an intermediate gear 55, mating with the input gear 54, and an output gear 56, secured on the nut 61 and mating with the intermediate gear 55.

A gear shaft 64 is supported on the first and second housings 52a, 52b. Bushes 65, of synthetic resin, are interposed either on one or both of the spaces between the gear shaft 64 and intermediate gear 55 or between the first and second housing portions 52a, 52b and the gear shaft 64. Thus, the intermediate gear 55 can be rotationally supported relative to the housing 52. Accordingly, it is possible to provide an electric actuator 51 that can interrupt or reduce transmission of vibration caused by play between the intermediate gear 55 and the gear shaft 64 as well as by play of gear shaft 64 itself.

In the prior art electric actuator 51, the rotational power of the electric motor 53 is transmitted to the nut 61 of the ball screw mechanism 58 via the speed reduction mechanism 57. The speed reduction mechanism 57 includes the input gear 54, the intermediate gear 55 and the output gear 56. The nut 61 is rotationally supported by a pair of the supporting deep groove ball bearings 66. The output gear 56 is arranged between two supporting bearings 66 and is secured on the nut 61 while being contacted by one of the supporting bearings 66.

The inner rings 67 of the bearings 66 are secured on the outer circumference 61b of the nut 61. Thus, they are rotated together with the nut 61. On the other hand, the outer rings 68 of the bearings 66 cannot rotate since they are securely fit in the housing 52. Accordingly, smooth rotation of the output gear 56 would be impaired if the side surface of the output gear 56 contacts the end face of the outer ring 68 of the bearing 66. Thus, the output gear 56 is formed so that its axial thickness is smaller than its boss 56a. The boss 56a contacts the inner ring 67 of the bearing 66. This prevents contact of the output gear 56 against the outer ring 68 of the bearing 66. Also, it reduces the weight of the output gear 56 (see, JP 2013-148108 A).

In the prior art electric actuator 51, sometimes offensive abnormal noises occurs due to teeth hitting sounds caused by backlash between the input gear 54, intermediate gear 55 and output gear 56 of the speed reduction mechanism 57. The teeth hitting sounds will be transmitted to other mechanical parts of the ball screw mechanism 58, for example, via the gear body of the output gear 56 and would finally cause resonance on the entire apparatus. In order to prevent the generation of the abnormal noise, a known low noise gear 69, shown in FIG. 6, has been used as a vibration absorbing gear. The low noise gear 69 includes a metallic gear 72 with a body portion 70 and a tooth portion 71 formed on an outer circumference of the body portion 70. A vibration absorbing member 73 is, by insert molding, formed on the body portion 70 of the metallic gear 72.

Recessed portions 74a, 74b are formed on both sides of the body portion 70. A communication portion 74c is formed between the recessed portions 74a, 74b to communicate them to each other. The communication portion 74c has a cross-section area smaller than that of the recessed portion 74a or 74b. A vibration absorbing member 73 is formed to fill the recessed portions 74a, 74b and the communication portion 74c in a manner so that it cannot be separated from the body portion 70. The vibration absorbing member 73 is formed of synthetic rubber with anti-heat and anti-oil properties superior in damping effect (see, JP 09-177943 A).

In the prior art low noise gear 69, shown in FIG. 6, it is possible to damp vibrations generated in the tooth portion 71. Also, it is possible to prevent the vibration absorbing member 73 from being separated from the body portion 70 of the metallic gear 72. However, since the vibration absorbing member 73, formed of elastic member, is arranged between the body portion 70 and the boss portion, which are separated from each other, rotational rigidity of the vibration absorbing member 73 is small to transmit a large torque. Thus, exact rotational amount of the electric motor 53 cannot be converted as exact linear motion of the drive shaft 59 due to elastic deformation of the vibration absorbing member 73.

In addition, when such a low noise gear 69 is applied to the output gear 56 shown in FIG. 5 and arranged adjacent to the supporting bearing 66, the vibration absorbing member 73 tends to contact the outer ring 68 of the supporting bearing 66. Accordingly, smooth rotation of the output gear 56 is impaired. Thus, it is difficult to be successful at both vibration absorption and weight-lightening.

### SUMMARY

It is, therefore, an object of the present disclosure to provide a gear that comprises a vibration absorbing member of vulcanized rubber in a plurality of weight-lightening apertures to prevent dropout of the vibration absorbing member from the gear. It is designed to prevent the vibration absorbing member from contacting an outer ring of a supporting bearing. Thus, the disclosure provides both a reduction of abnormal noise by damping vibration of the teeth of the gear and a smooth rotation of the gear as well as provides an electric actuator using such a gear.

To achieve the object of the present disclosure, a gear comprises teeth formed on the outer circumference of the gear. A central hole is formed at the center of the gear. An intermediate region is between a peripheral portion near the teeth and a boss near the central hole. The intermediate region is formed with a thickness thinner than those of the peripheral portion and the boss. A plurality of weight-lightening apertures is formed circumferentially and equidistantly in the intermediate region. A vibration absorbing member of synthetic rubber is integrally formed on both side surfaces of the intermediate region with each other through the weight-lightening apertures. The vibration absorbing member is attached to the radially outer side than to the outer diameter of a bearing to be arranged adjacent to the vibration absorbing member.

The gear of the present disclosure comprises teeth formed on the outer circumference of the gear and a central hole formed at the center of the gear. An intermediate region is between a peripheral portion near the teeth and a boss near the central hole. The intermediate region has a thickness thinner than those of the peripheral portion and the boss. A plurality of weight-lightening apertures is formed circumferentially and equidistantly in the intermediate region. A vibration absorbing member, of synthetic rubber, is formed on both side surfaces of the intermediate region. The sides are integrally connected to each other through the weight-lightening apertures. The vibration absorbing member is attached to the radially outer sides rather than the outer diameter of a bearing to be arranged adjacent to the vibration absorbing member. Thus, it is possible to improve the reliability while preventing peeling-off or dropout of the vibration absorbing member. This suppresses the generation of abnormal noise such as a teeth hitting sound while reducing vibration of the teeth and simultaneously reducing the weight of the gear. Thus, this ensures smooth rotation of the gear while preventing contact of the gear with the outer ring of the bearing.

The weight-lightening apertures are arranged at a position near the outer circumference of the intermediate region. This reduces the rotational inertia and also improves the strength and durability of the gear.

Each weight-lightening aperture has a configuration of a rectangle or a triangle expanding radially outward. This reduces the weight of the gear while increasing the size of weight-lightening aperture.

The side surfaces of the vibration absorbing member are configured so that they are flush with those of the peripheral portion and the boss. This easily forms the vibration absorbing member. Thus, this surely obtains desired accuracy of its dimensions.

The gear is formed of sintered alloy. This enables exact forming of the gear in a desired configuration and dimensions even though the gear has a complicated configuration requiring high machining accuracy.

An electric actuator comprises a housing, a nut, a screw shaft, an electric motor mounted on the housing and a speed reduction mechanism transmitting rotational force of the motor to a ball screw mechanism, via a motor shaft. The ball screw mechanism converts the rotational motion of the electric motor to the axial linear motion of a drive shaft, via the speed reduction mechanism. The nut is formed with a helical screw groove on its inner circumference. The nut outer circumference includes an output gear that forms part of the speed reduction mechanism. The nut is rotationally but axially immovably supported relative to the housing by a pair of supporting bearings mounted on the housing. The screw shaft outer circumference has a helical screw groove corresponding to the helical screw groove of the nut. The screw shaft is adapted to be inserted into the nut, via a large number of balls. The screw shaft is non-rotationally but axially movably supported relative to the housing. The output gear is secured on the outer circumference of the nut. It is sandwiched by an inner ring of one supporting bearing and a flange portion of the nut. The output gear is configured by the previously defined gear.

The electric actuator includes a speed reduction mechanism to transmit rotational force of an electric motor to a ball screw mechanism. The ball screw mechanism is able to convert the rotational motion of the electric motor to axial linear motion of a drive shaft, via the speed reduction mechanism. The nut is formed with a helical screw groove on its inner circumference. The nut outer circumference includes an output gear forming part of the speed reduction mechanism. The nut is rotationally but axially immovably supported relative to the housing by a pair of supporting bearings mounted on the housing. The screw shaft outer circumference includes helical screw groove corresponding to the helical screw groove of the nut. The screw shaft is adapted to be inserted into the nut, via a large number of balls. The screw shaft is non-rotationally but axially movably supported relative to the housing. The output gear is configured by the previously defined gear. The gear is secured on the outer circumference of the nut. It is sandwiched by an inner ring of one supporting bearing and a flange portion of the nut. Thus, it is possible to provide an electric actuator that can assure smooth rotation of the output gear while preventing the output gear from contacting the outer ring of the bearing. This suppresses the generation of abnormal noise, that would be caused during meshing of the output gear, while damping vibration of the gear teeth.

The gear comprises teeth formed on its outer circumference and a central hole formed at its center. An intermediate region is between a peripheral portion near the teeth and a boss near the central hole. The intermediate region has a thickness thinner than the peripheral portion and the boss. A plurality of weight-lightening apertures is formed circumferentially and equidistantly in the intermediate region. A vibration absorbing member of synthetic rubber is formed on both side surfaces of the intermediate region. The vibration absorbing side members are integrally connected to each other through the weight-lightening apertures. The vibration absorbing member is attached to the radially outer side rather than the outer diameter of a bearing to be arranged adjacent to the vibration absorbing member. Thus, this improves the reliability while preventing peeling-off or dropout of the vibration absorbing member. This suppresses the generation of abnormal noise, such as a teeth hitting sound, while reducing vibration of the teeth and simultaneously reducing the weight of the gear. Thus, this ensures smooth rotation of the gear while preventing contact of the gear with the outer ring of the bearing.

The electric actuator comprises a housing, a nut, a screw shaft, an electric motor mounted on the housing and a speed reduction mechanism transmitting rotational force of the motor to a ball screw mechanism, via a motor shaft. The ball screw mechanism converts the rotational motion of the electric motor to the axial linear motion of a drive shaft, via the speed reduction mechanism. The nut has a helical screw groove on its inner circumference. The nut outer circumference includes an output gear forming part of the speed reduction mechanism. The nut is rotationally but axially immovably supported relative to the housing by a pair of supporting bearings mounted on the housing. The screw shaft outer circumference has a helical screw groove corresponding to the helical screw groove of the nut. The screw shaft is adapted to be inserted into the nut, via a large number of balls. The screw shaft is non-rotationally but axially movably supported relative to the housing. The output gear is configured as the above defined gear. The gear is secured on the outer circumference of the nut and is sandwiched by an inner ring of one supporting bearing and a flange portion of the nut. Thus, the electric actuator can assure smooth rotation of the output gear while preventing the output gear from contacting the outer ring of the bearing. This suppresses the generation of abnormal noise, that would be caused during meshing of the output gear, while damping vibration of the gear teeth.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a longitudinal section view of a preferable embodiment of an electric actuator.

FIG. 2 is an enlarged longitudinal section view of the ball screw mechanism of FIG. 1.

FIG. 3(a) is a perspective view of a configuration of weight-lightening apertures of an output gear.

FIG. 3(b) is a perspective view of a comparative example of the configuration of weight-lightening apertures of an output gear.

FIG. 3(c) is a perspective view of another comparative example of the configuration of weight-lightening apertures of an output gear.

FIG. 4(a) is an explanatory view of a relative arrangement between an output gear and its supporting bearing.

FIG. 4(b) is a perspective view of a mounted state between an output gear and its supporting bearing.

FIG. 5 is a longitudinal section view of a prior art electric actuator.

FIG. 6 is a schematic longitudinal section view of an output gear of the prior art electric actuator.

### DETAILED DESCRIPTION

An electric actuator comprises an aluminum alloy housing. An electric motor is mounted on the housing. A speed reduction mechanism transmits rotational force of the motor to a ball screw mechanism, via a motor shaft. The ball screw mechanism converts the rotational motion of the electric motor to the axial linear motion of a drive shaft, via the speed reduction mechanism. A nut is formed with a helical screw groove on its inner circumference. The nut outer circumference includes an output gear forming part of the speed reduction mechanism. The nut is rotationally but axially immovably supported relative to the housing by a pair of supporting bearings mounted on the housing. A screw shaft is coaxially integrated with the drive shaft. The screw shaft outer circumference has a helical screw groove corresponding to the helical screw groove of the nut. The screw shaft is adapted to be inserted into the nut, via a large number of balls. The screw shaft is non-rotationally but axially movably supported relative to the housing. The output gear is secured on the outer circumference of the nut. The output gear is sandwiched by an inner ring of one supporting bearing and a flange portion of the nut. The output gear includes teeth formed on its outer circumference and a central hole at its center. An intermediate region is between a peripheral portion near the teeth and a boss near the central hole. The intermediate region has a thickness thinner than those of the peripheral portion and the boss. A plurality of weight-lightening apertures, with rectangle expanding radially outward configuration, is formed circumferentially and equidistantly in the intermediate region. A vibration absorbing member, of synthetic rubber, is formed on both side surfaces of the intermediate region. Both sides of the vibration absorbing member integrally connect to each other through the weight-lightening apertures. The vibration absorbing side members are attached to the radially outer sides rather than the outer diameter of a bearing to be arranged adjacent to the vibration absorbing member.

One preferable embodiment of the present disclosure will be hereinafter described with reference to the drawings.

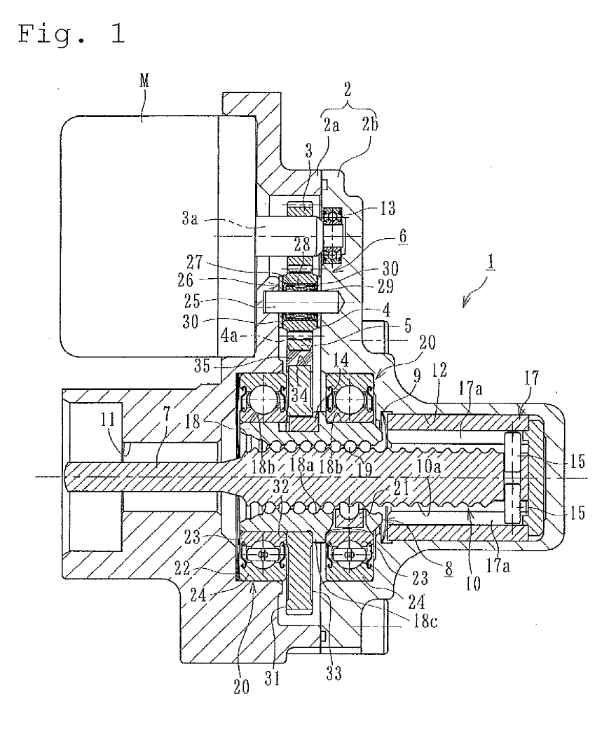

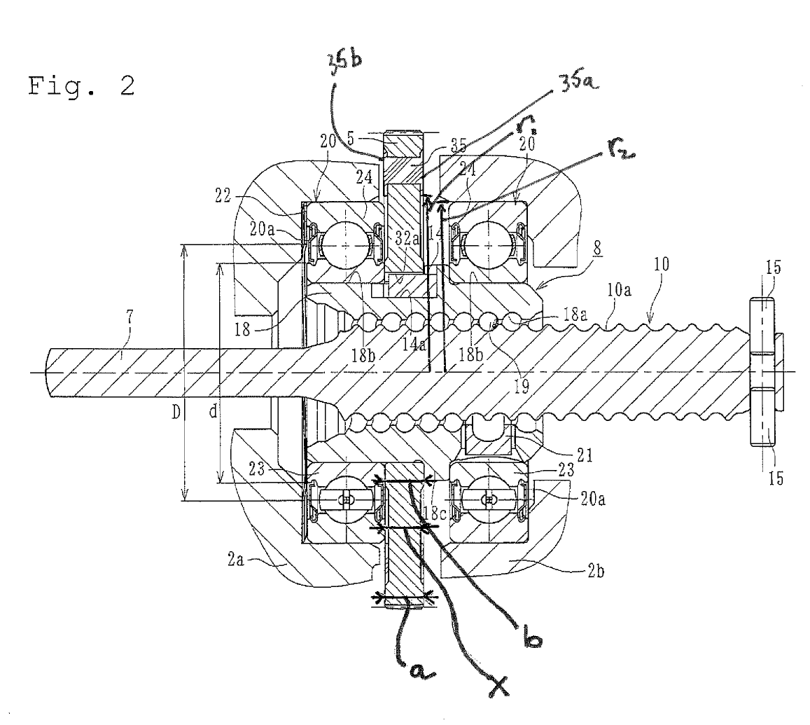

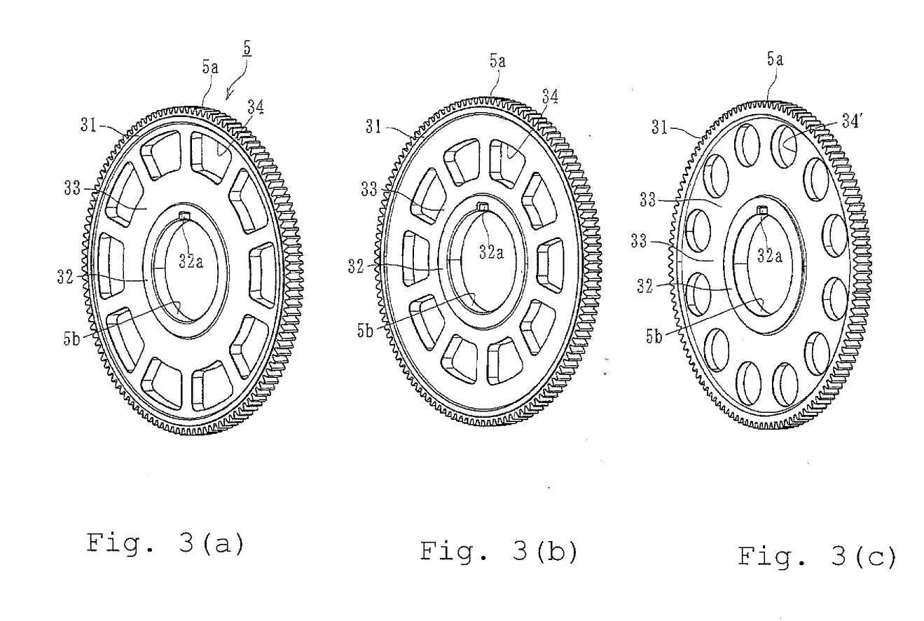

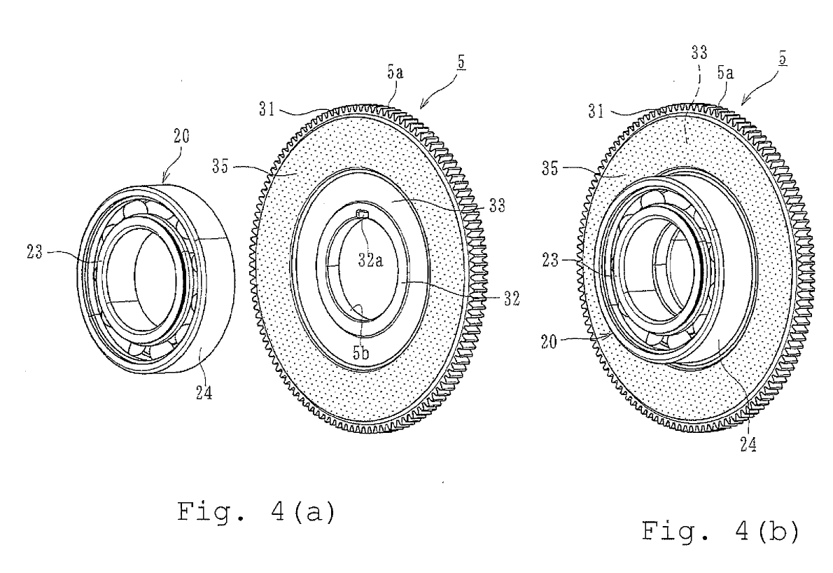

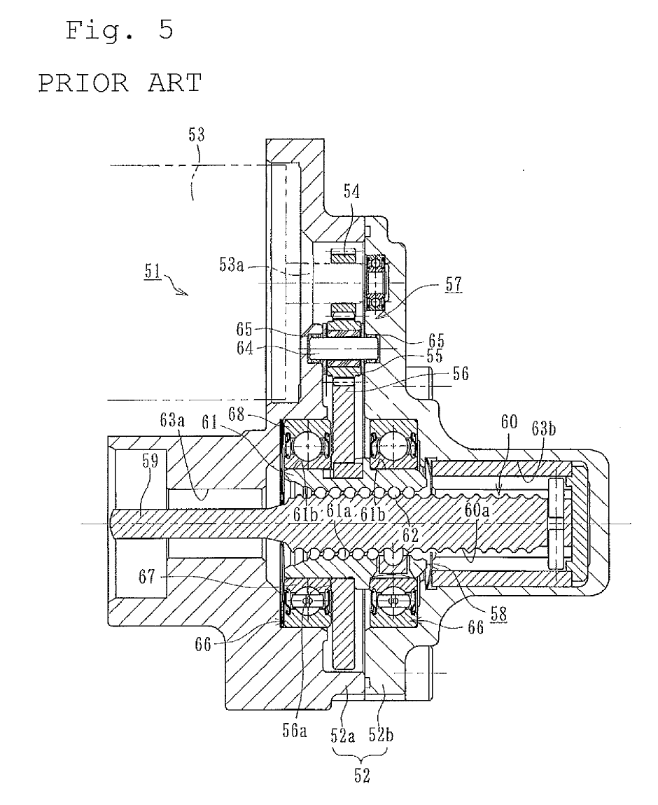

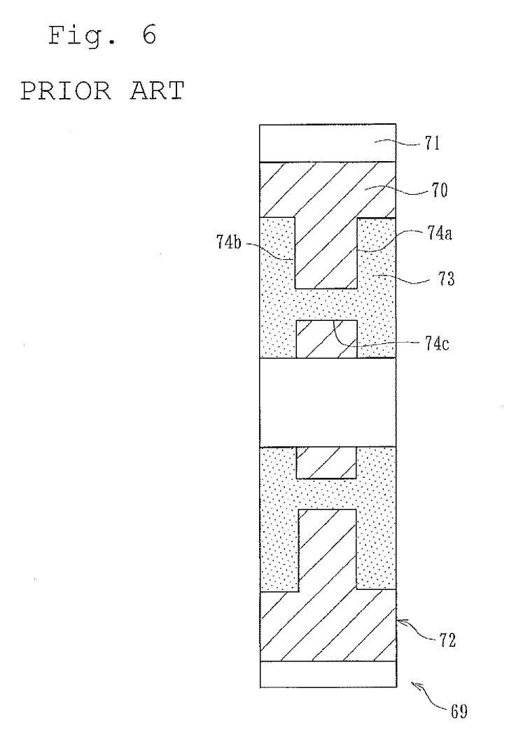

FIG. 1 is a longitudinal section view of one preferable embodiment of an electric actuator. FIG. 2 is an enlarged longitudinal section view of the ball screw mechanism of FIG. 1. FIG. 3(a) is a perspective view of a configuration of weight-lightening apertures of an output gear. FIG. 3(b) is a perspective view of a comparative example of a configuration of weight-lightening apertures of an output gear. FIG. 3(c) is a perspective view of another comparative example of a configuration of weight-lightening apertures of an output gear. FIG. 4(a) is an explanatory view of a relative arrangement between an output gear and its supporting bearing. FIG. 4(b) is a perspective view of a mounted state between an output gear and its supporting bearing.

As shown in FIG. 1, the electric actuator 1 comprises a cylindrical housing 2, an electric motor M mounted on the housing 2, and a speed reduction mechanism 6. The speed reduction mechanism 6 includes an input spur gear 3 secured on a motor shaft 3a of the electric motor M. An intermediate gear 4 mates with the input gear 3. An output gear 5 mates with the intermediate gear 4 and is mounted on the outer circumference of a nut 18. A ball screw mechanism 8 converts rotational motion of the electric motor M to axial linear motion of a drive shaft 7, via the speed reduction mechanism 6.

The housing 2 is formed from aluminum alloy such as A 6063 TE, ADC 12 etc. It is die casting and includes a first housing 2a and second housing 2b. The electric motor M is mounted on the first housing 2a. The second housing 2b abuts and is bolted to an end face of the first housing 2a by fastening bolts (not shown). The first housing 2a and the second housing 2b are formed with a through bore 11 and a blind bore 12, respectively, to contain the screw shaft 10, as described later.

The input gear 3 is press-fit onto the end of the motor shaft 3a of the electric motor M. Thus, the input gear is non-rotatable relative to the shaft 3a but is rotationally supported by a rolling bearing 13. The rolling bearing 13 has a deep groove ball bearing mounted on the second housing 2b. The output gear 5 mates with the intermediate spur gear 4. The output gear 5 is integrally secured on the nut 18, via a key 14, that forms part of the ball screw mechanism 8.

The drive shaft 7 is integrally formed with a screw shaft 10 that forms part of the ball screw mechanism 8. Guide pins 15, 15 are mounted on one end (right-side end in FIG. 1) of the drive shaft 7. A sleeve 17 is fit in the blind bore 12 of the second housing 2b. Axially extending recessed grooves 17a, 17a are formed, by grinding, on the inner circumference of the sleeve 17. The recessed grooves 17a, 17a are arranged circumferentially opposite. The guide pins 15, 15 engage the grooves 17a, 17a to axially removably support the screw shaft 10. Falling-out of the sleeve 17 is prevented by a stopper ring 9 mounted on an opening of the blind bore 12 of the second housing 2b.

The sleeve 17 is formed from sintered alloy by an injection molding machine that molds plastically prepared metallic powder. In this injection molding, metallic powder and binder, comprising plastics and wax, are first mixed and kneaded by a mixing and kneading machine to form pellets from the mixed and kneaded material. The pellets are fed into a hopper of the injection molding machine. The pellets are then pushed into dies under a heated and melted state and finally form the sleeve by a so-called MIM (Metal Injection Molding) method. The MIM method can easily mold sintered alloy material articles having desirable accurate configurations and dimensions even though the article require high manufacturing technology and have configurations that are hard to form.

The guide pins 15 are formed of high carbon chromium bearing steel such as SUJ 2 or carburized bearing steel such as SCr 435. The pin surfaces are formed with carbonitrided layer having carbon content more than 0.80% by weight with a hardness of more than HRC 58. In this case, it is possible to adopt needle rollers, used in needle bearings, as guide pins 15. This makes it possible to have the guide pins 15 with a hardness of more than HRC 58 and have excellent anti-wear properties, availability and manufacturing cost.

As shown in the enlarged view of FIG. 2, the ball screw mechanism 8 includes the screw shaft 10 and the nut 18, inserted on the screw shaft 10, via balls 19. The screw shaft 10 outer circumference includes a helical screw groove 10a. The screw shaft 10 is axially movably supported in the housing. The nut 18 inner circumference includes a screw groove 18a corresponding to the screw groove 10a of the screw shaft 10. A plurality of balls 19 is rollably contained between the screw grooves 10a, 18a. The nut 18 is rotationally and axially immovably supported by two supporting bearings 20, 20 relative to the housings 2a, 2b. A numeral 21 denotes a bridge member to achieve an endless circulating passage of balls 19 through the screw groove 18a of the nut 18.

The cross-sectional configuration of each screw groove 10a, 18a may be either one of a circular-arc or Gothic-arc configuration. However, the Gothic-arc configuration is adopted in this embodiment. Thus, it can have a large contacting angle with the ball 19 and set a small axial gap. This provides a large rigidity against axial loads and thus suppresses the generation of vibration.

The nut 18 is formed of case hardened steel such as SCM 415 or SCM 420. The nut surface is hardened to HRC 55 to 62 by vacuum carburizing hardening. This omits treatments, such as buffing for scale removal after heat treatment, to reduce the manufacturing cost. The screw shaft 10 is formed of medium carbon steel such as S55C or case hardened steel such as SCM 415 or SCM 420. The screw shaft surface is hardened to HRC 55 to 62 by induction hardening or carburizing hardening.

The output gear 5, forming part of the speed reduction mechanism 6 is firmly secured on the outer circumference 18b of the nut 18, via a key 14. The support bearings 20, 20 are press-fit onto the nut 18, via a predetermined interference, at both sides of the output gear 5. More particularly, as shown in FIG. 2, the output gear 5 is secured on the nut 18 by the key 14 fit into a rectangular key way space 14a formed on an outer circumference 18b of the nut 18. A key way 32a is formed on an inner circumference of the output gear 5. The output gear 5 is sandwiched by an inner ring 23 of the supporting bearing 20, arranged at the side of the first housing 2a, and a nut flange portion 18c. The supporting bearing 20, arranged at the side of the second housing 2b, is secured on the outer circumference 18b of the nut 18. It is sandwiched by the nut flange portion 18c and the second housing 2b. This prevents both the supporting bearings 20, 20 and output gear 5 from axially shifting even though strong thrust loads are applied to them from the drive shaft 7. Each supporting bearing 20 comprises a deep groove ball bearing. Shield plates 20a, 20a are mounted on both sides of the balls. The shield plates 20a, 20a prevent lubricating grease sealed within the bearing body from leaking outside. Also, the plates 20a, 20a prevent abrasive debris from entering into the bearing body from outside.

In the present embodiment, both the supporting bearings 20, 20 are formed by deep groove ball bearing with the same specifications. Thus, it is possible to support both a thrust load applied by the drive shaft 7 and a radial load applied by the output gear 5. Also, this simplifies confirmation work to prevent errors during assembly of the bearing. Further, this improves the assembling operability. In this case, the term “same specifications” means that the deep groove ball bearings have the same inner diameters, outer diameters, width dimensions, rolling element sizes, rolling element numbers and internal clearances.

The pair of supporting bearings 20, 20 are fit into the first and second housings 2a, 2b, via radial clearance. One support bearing 20, of these paired bearings 20, 20, is mounted on the first housing 2a via a washer 22. The washer 22 includes a ring-shaped elastic member.

The washer 22 is a wave washer press-formed of austenitic stainless steel (JIS SUS 304 etc.) or preserved cold rolled steel sheet (JIS SPCC etc.). The washer 22 has high strength and wear resistance. An inner diameter D of the washer 22 is larger than an outer diameter d of the inner ring 23, of the supporting bearing 20. The washer 22 urges the supporting bearing 20 toward the adjacent output gear 5. This eliminates axial play of the pair of supporting bearings 20, 20. Thus, rotation of the nut 18 is smooth. In addition, the washer 22 contacts only the outer ring 24 of the supporting bearing 20. The washer 22 does not contact the rotational inner ring 23. This prevents the inner ring 23 of the supporting bearing 20 from contacting the housing 2a even if the nut 18 is urged toward the housing 2a by a reverse-thrust load. Thus, this prevents the nut 18 from being locked by an increase of the frictional force.

Returning to FIG. 1, a gear shaft 25, of the intermediate gear 4 forming part of the speed reduction mechanism 6, is fit into the first and second housings 2a, 2b. The intermediate gear 4 is rotationally supported on the gear shaft 25 via a rolling bearing 26. One end, first housing 2a-side end, of the gear shaft 25 is press fit into the first housing 2a. This enables assembling misalignment and obtains smooth rotational performance by performing the clearance fitting of the other end, second housing 2b-side end. The rolling bearing 26 is a needle roller bearing of a so-called shell type. It includes an outer ring 27 and a plurality of needle rollers 29. The outer ring 27 is press-formed from a steel sheet. The outer ring is press-fit into an inner circumference of the intermediate gear 4. The plurality of needle rollers 29 is rollably contained in the outer ring 27, via a cage 28. This enables the adoption of easily or readily available bearings or a standard design and thus reduces manufacturing cost.

Ring-shaped washers 30, 30 are installed on both sides of the intermediate gear 4. The washers 30, 30 prevent direct contact of the intermediate gear 4 against the first and second housings 2a, 2b. In this embodiment, the face width of the teeth 4a of the intermediate gear 4 is formed smaller than an axial width of the gear blank. This reduces the contact area between the intermediate gear 4 and the washers 30, 30. Thus, this reduces their frictional resistance and obtains smooth rotational performance. The washers 30 are flat washers press-formed from austenitic stainless steel sheet or preserved cold rolled steel sheet with high strength and frictional resistance. Alternatively, the washers 30 may be formed of brass, sintered metal or thermoplastic synthetic resin such as PA (polyamide) 66. The thermoplastic synthetic resin is impregnated with a predetermined amount of fiber reinforcing material such as GF (glass fibers).

The output gear 5 is formed from a sintered alloy. The output gear includes spur teeth 5a, on its circumference, and a central hole 5b. The central hole 5b is a circular hole adapted to be fit onto the outer circumference 18b of the nut 18, as shown in FIG. 3(a). An intermediate region 33 is between a peripheral portion 31, near the teeth 5a, and a boss 32, near the central hole 5b. The peripheral portion 31 has a thickness (a). The boss 32 has a thickness (b). The intermediate region 33 has a thickness (x) thinner than those of the peripheral portion 31 and the boss 32. Thus, a>x and b>x. A plurality of weight-lightening apertures 34 are formed equidistantly in the intermediate region 33 along its circumference. Each weight-lightening aperture 34 has a rectangle expanding radially outward configuration. A key way 32a, engaging with securing key 14, is formed on the inner circumference of the boss 32. Although illustrated with rectangular weight-lightening apertures 34 that are effective for reducing the weight of the gear, the shape of each aperture 34 is not limited to a rectangle or any other shape. An egg-shape or a triangle with an expanding toward radially outward configuration may be possible if the weight-lightening apertures 34 can reduce the weight of the output gear 5 while maintaining strength and rigidity.

The metallic powder for the sintering alloy includes completely alloyed powder, atomized iron powder of alloyed and melted steel where alloyed components are uniformly distributed in grains, or partially alloyed powder alloyed powder where partially alloyed powder is adhered to pure iron powder of Fe, Mo and Ni. One example of the alloyed powders is a hybrid type alloy powder (trade name JIP 21 SX of JFE steel Co., Japan). Here, the pre-alloy copper powder includes Fe of 2% by weight, Ni of 1% by weight and Mo is adhered to fine Ni powder, Cu powder and graphite powder via binder. This hybrid type alloy powder is able to obtain high mechanical strength, tensioning strength and hardness, due to an increase of the martensite phase ratio to the metallic structure of the sintered body while increasing the cooling speed, higher than 50° C./min, after sintering. This eliminates heat treatment after sintering and provides a high accuracy output gear. It is preferable to have Mo of 0.5 to 1.5% by weight in order to improve the hardenability. Ni of 2 to 4% by weight is added to improve the toughness of the sintered body. Similar to the sleeve 17 described above, the output gear 5 may be formed of sintered alloy by the MIM method.

According to the present embodiment, the weight-lightening apertures 34 of the output gear 5 are arranged at a position near the outer circumference of the intermediate region 33, as shown in FIG. 3(a). This reduces the moment of inertia that is proportional to the square of the radius of the output gear 5. Also, this improves the strength and durability of the gear compared to where the weight-lightening apertures 34 are arranged at a position near the boss 32 in the intermediate region 33, as shown in FIG. 3(b). This arrangement further contributes to weight reduction as compared to the case where circular weight-lightening apertures 34′ are provided as shown in FIG. 3(c).

According to the present embodiment, a vibration absorbing member 35 is integrally adhered by vulcanized adhesion to the thin walled intermediate region 33. Thus, synthetic rubber side surfaces 35a and 35b are on both sides of the intermediate region 33. The side surfaces 35a and 35b are connected to each other through the weight-lightening apertures 34, as shown in FIG. 4. The vibration absorbing member 35 is formed of synthetic rubber such as NBR (acrylonitrile-butadiene rubber). It is adhered to the intermediate region 33 in a radially outer region rather than the outer diameter of the outer ring 24 of an adjacent supporting bearing 20, as shown in FIG. 4(a). In addition, the side surfaces 35a and 35b of the vibration absorbing member 35 are configured so that they are substantially flush with the peripheral portion 31 and the boss 32. This makes it easy to form the vibration absorbing member 35 and to assure the desired dimensional accuracy. In addition, the vibration absorbing member 35 is connected on both sides of the intermediate region 33 through the weight-lightening apertures 34. Thus, this improves the reliability and prevents peeling-off or dropping out of the vibration absorbing member 35. Further, it suppresses the generation of abnormal noise, such as teeth hitting sound, while reducing vibration of the teeth and simultaneously reducing the weight of the gear 5. The inner radius r₁ of the side surfaces 35a and 35b is greater than the outer radius r₂ of the support bearing 20 (r₁>r₂). This ensures smooth rotation of the gear 5 while preventing contact of the gear 5 with the outer ring 24 of the bearing 20, as shown in FIG. 4(b). In this specification, the term “substantially flush” means only target values in design and thus errors caused by machining should be naturally allowed.

Examples of the material of the vibration absorbing member 35, other than previously mentioned NBR, is HNBR (hydrogenation acrylonitric-butadiene rubber) superior in heat resistance, EPM, EPDM, ACM (poly-acrylic rubber) and FKM (fluororubber) superior in heat and chemical resistance.

The gear of the present disclosure can be used as an output gear of an electric actuator provided with a ball screw mechanism to convert a rotational input motion, from an electric motor, to a linear motion of a drive shaft, via a gear reduction mechanism. Electric motors for general industry use or drive parts of an automobile etc are included.

The present disclosure has been described with reference to the preferred embodiments. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

What is claimed is:

1. A gear comprising:
teeth formed on an outer circumference of the gear;
a central hole formed at a center of the gear;
an intermediate region is positioned between a peripheral portion near the teeth and a boss near the central hole, the intermediate region has a thickness thinner than the peripheral portion and the boss;
a plurality of weight-lightening apertures is circumferentially and equidistantly formed in the intermediate region; and
a vibration absorbing member, of synthetic rubber, is formed on the gear, the vibration absorbing member includes side surfaces integrally connect with each other through the weight-lightening apertures, the vibration absorbing member is attached to the intermediate region of the gear rather than an outer diameter of a bearing arranged adjacent to the vibration absorbing member.

2. The gear of claim 1, wherein the weight-lightening apertures are arranged at a position near the outer circumference of the intermediate region.

3. The gear of claim 1, wherein each weight-lightening aperture has a rectangle or triangle expanding radially outward configuration.

4. The gear of claim 1, wherein the side surfaces of the vibration absorbing member are configured to be flush with the peripheral portion and the boss.

5. The gear of claim 1, wherein the gear is formed of sintered alloy.

6. An electric actuator comprising:
a housing;
an electric motor mounted on the housing;
a speed reduction mechanism for transmitting rotational force of the motor (M) to a ball screw mechanism via a motor shaft; and
the ball screw mechanism converts the rotational motion of the electric motor (M) to axial linear motion of a drive shaft, via the speed reduction mechanism, the speed reduction mechanism includes an output gear on an outer circumference of a nut, the nut is rotationally but axially immovably supported relative to the housing by a pair of supporting bearings mounted on the housing, the nut includes a helical screw groove on its inner circumference;
a screw shaft includes an outer circumference with a helical screw groove corresponding to the helical screw groove of the nut, the screw shaft is adapted to be inserted into the nut, via a number of balls, the screw shaft is axially movably and non-rotationally supported relative to the housing;
the output gear is secured on the outer circumference of the nut, the output gear is sandwiched by an inner ring of one supporting bearing and a flange portion of the nut; and
the output gear is configured by a gear defined by claim 1.
